(19) United States
(12) Patent Application Publication
(10) Pub. No.: US 2015/0247084 A1
(43) Pub. Date: Sep. 3, 2015

(54) CERAMIC ISOLATION BALL FOR FRACTURING SUBSURFACE GEOLOGIC FORMATIONS

(71) Applicant: Jeffrey Stephen Epstein, Houston, TX (US)

(72) Inventor: Jeffrey Stephen Epstein, Houston, TX (US)

(21) Appl. No.: 14/637,034

(22) Filed: Mar. 3, 2015

Related U.S. Application Data
(60) Provisional application No. 61/947,271, filed on Mar. 3, 2014.

(51) Int. Cl. C09K 8/80; B28B 11/24

(52) U.S. Cl. CPC C09K 8/805; B28B 11/24; B29L 2022/00

(57) ABSTRACT

An embodiment of a ceramic isolation ball is provided to cooperate with a ball seat to isolate a first portion of a well drilled into the earth's crust from a second portion of the well. Embodiments of the ball of the present invention are comprised of a ceramic material with excellent resistance to deformation when received into a ball seat and subjected to very high pressure differentials tending to force the ball into the ball seat to isolate a portion of a borehole below or beyond the ball and ball seat from a portion of the borehole above or before the ball and ball seat. Embodiments of the ball of the present invention include a hollow interior and a hole that receives a plug to close the hollow interior to prevent fluid intrusion therein. The ball is used to isolate a portion of a well during high-pressure fracturing operations.

### CROSS-REFERENCE TO RELATED APPLICATIONS

This application depends from and claims priority to U.S. Provisional Patent Application Ser. No. 61/947,271 filed on Mar. 3, 2014, which application is incorporated by reference herein.

### BACKGROUND

1. Field of the Invention

The present invention relates to an improved ceramic isolation ball for use with a ball seat for isolating a first subsurface geologic zone from a second geologic zone to be subjected to hydraulic fracturing operations to enhance production of hydrocarbons.

2. Background of the Related Art

Hydraulic fracturing is the fracturing the rock in a geologic formation using a highly pressurized fracturing liquid. Some hydraulic fractures form naturally in a geologic formation, but an induced hydraulic fracture formed by hydro-fracturing, more commonly known as “fracking,” is a technique by which a volume of water, or some other carrier liquid, mixed with sand and chemicals is injected at a high pressure into a portion of a well to create fractures (typically less than 1 mm wide) through which fluids residing in the formation, such as gas, oil, condensate or other recoverable minerals, may migrate to the wellbore for production to the surface end of the well. Hydraulic pressure is removed from the fractured well and small grains of proppant, for example, sand or aluminum oxide, remain to hold the fractures open once the formation rock is restored to equilibrium. Fracking is commonly used to recover fluids in shale gas, tight gas, tight oil and coal seam gas and hard rock wells. This well stimulation technique is generally only conducted once in the life of the well and greatly enhances fluid removal and well productivity.

A hydraulic fracture is formed by pumping fracturing fluid into the well at a rate sufficient to increase pressure downhole at a targeted zone (determined by the location of the well casing perforations) to exceed that of the fracture gradient (pressure gradient) of the rock. The fracture gradient is defined as the pressure increase per unit of the depth due to its density and it is usually measured in pounds per square inch per foot or bars per meter. The rock cracks and the fracture fluid continues further into the rock, extending the crack still further, and so on. Fractures are localized because pressure drop off with frictional loss attributed to the distance from the well. Operators typically try to maintain “fracture width,” or slow its decline, following treatment by introducing into the injected fluid a proppant—a material such as grains of sand, ceramic beads or other particulates that prevent the fractures from closing when the injection is stopped and the pressure of the fluid is removed. The propped fracture is permeable enough to allow the flow of formation fluids to the well. Formation fluids include gas, oil, salt water and fluids introduced to the formation during completion of the well during fracturing.

The location of one or more fractures along the length of the borehole is strictly controlled by various methods that create or seal off holes in the side of the well. A well may be fracked in stages by setting a ball seat within the well casing and below or beyond the targeted geologic formation to isolate one or more lower zones that are open to the well from the anticipated fracking pressure. A ball of a predetermined diameter is introduced into the well at the surface and pumped downhole. When the ball reaches the ball seat, the ball seats in the ball seat to form a pressure seal and to isolates the geologic formation zones below or beyond the ball seat from the anticipated hydraulic fracturing pressure to be exposed on a geologic formation zone above or before the ball seat.

Hydraulic-fracturing equipment used in oil and natural gas fields usually consists of a slurry blender, one or more high-pressure, high-volume fracturing pumps (typically powerful triplex or quintuplex pumps) and a monitoring unit. Associated equipment includes fracturing tanks, one or more units for storage and handling of proppant, high-pressure treating iron, a chemical additive unit (used to accurately monitor chemical addition), low-pressure flexible hoses, and many gauges and meters for flow rate, fluid density, and treating pressure. Chemical additives are typically 0.5% percent of the total fluid volume. Fracturing equipment operates over a range of pressures and injection rates, and can reach up to 15,000 psig (100 megapascals) and 9.4 cu. ft./sec. (265 litres per second) (or about 100 barrels per minute).

A problem that can be encountered in a fracking operation involves the ball. After the fracking operation is concluded, the surface pressure is restored to a pressure at which the well will flow and produce formation fluids to the surface for recovery. A ball having a low density can be floated or backflowed from the well, but a ball having a low density may be deformed by the pressure differential applied across the ball seat and thereby compromised during fracturing operations. If the ball is of a material that is more dense so that it can not be floated or backflowed from the well to the surface or if it has become deformed, then the ball may present an unwanted obstruction that has to be removed from the well. A workover operation can be implemented in which a drilling instrument is introduced into the well to drill out and mechanically destroy the ball, but a workover operation imposes delays and substantial costs.

Wells that penetrate extremely deep into the earth's crust and wells that penetrate formations having a very high pressure may require very high pressures to fracture the formation rock. This requires a ball seat and a ball that can withstand the pressure differential applied thereto. Ball seats are generally made of metal for superior strength, but balls cannot be metal because the density of a metal ball would prevent it from being removed from the well by backflowing the well. The ball seat, when empty, should allow a generally unimpeded flow of fluids through the ball seat. A metal ball would have superior strength, but it would have such a high density that the flow of fluids from the well would not enable the ball to be removed from the well because the ball would not become entrained in the flow to the surface. Conventional plastic balls lack the strength and structural integrity to withstand extreme pressure differentials required for fracking these high pressure formations. More specifically, the pressure differentials required to fracture formations having an extremely high pressure cause conventional plastic balls to implode, rupture or deform to the extent that the seal at the ball seat is lost and the fracking pressure is unachievable.

What is needed is a ball that has a resistance to deformation so that it can be used in conjunction with a ball seat to reliably isolate geologic formation zones below the ball seat from extremely high fracturing pressures applied to geologic formation zones above and before the ball seat and a density that allows the ball to be broken up or removed from the well by backflowing to as not to present a well obstruction.

### BRIEF SUMMARY

One embodiment of the present invention provides a ball for sealing with a ball seat in a well that is constructed to provide resistance to deformation as an extremely high pressure differential is applied to the seated ball and ball seat. An embodiment of the present invention provides a ball that can be deployed to seat in the ball seat, remain in the ball seat during exposure to extremely high pressure differentials there across, and backflowed from or broken up in the well. Embodiments of the ball of the present invention are made of a specially formulated and cast or isostatically pressed ceramic material that provides resistance to deformation under large pressure differentials across the ball and ball seat during fracking operations and favorable density to enable removal of the ball by backflowing or hammering the ball to break it up in the well to prevent an obstacle from remaining in the well. It will be understood that a variety of tools can be run into a well to engage and hammer an isolation ball to break it up into pieces. This enables the use of higher fracking pressures to increase the success of the fracking process.

One embodiment of the method of making a ball for use with a ball seat to isolate the pressure within a first portion of the well drilled into the earth's crust from a pressure within a second portion of the well of the present invention includes the steps of mixing and milling a ceramic powder with water, a dispersant and one or more gel-forming organic monomers to serve as a binder to form a mixture, subjecting the mixture to a partial vacuum to remove air from the mixture and to prevent the formation of bubbles that may otherwise result in structural flaws or porosity in the final solidified product, adding a polymerization initiator to the mixture to initiate a gel-forming chemical reaction and to thereby produce a ceramic slurry, adding a catalyst to the ceramic slurry, pouring the ceramic slurry into a molds to cast having a void in the shape of a hollow spherical ball having an opening to receive a plug, heating the mold containing the ceramic gel in a curing oven or a kiln for a period of 30 to 800 minutes at a temperature of 392° F. (200° C.) to 1,472° F. (800° C.), removing the hardened isolation ball from the mold, drying the isolation ball to remove most of the solvent and to minimize warping and cracking, machining the ceramic ball into a spherical shape, firing the ceramic ball, grinding ceramic ball, exposing the ceramic ball to heat for a sustained duration of time in a furnace to burn out the binder and sinter the cast material, air drying the ceramic ball at ambient temperature for 1 to 2 days, firing the ceramic ball in furnace at a temperature ranging from 1600° C. to 1800° C. for a duration of from 1 to 4.5 hours to densify the ceramic, and receiving a plug into a hole in the ball to seal the hollow interior.

Embodiments of the method of making the ceramic isolation ball may further include the step of using a ceramic powder comprising one of alumina, zirconia-toughened alumina, silicon nitride, tungsten carbide, zirconia, or a bulk metallic glass.

Embodiments of the method of making the ceramic isolation ball may further include the step of using a monomer comprising one of methacrylamide and hydroxymethlacrylamide. Embodiments of the method of making the ceramic isolation ball may further include the step of using a monomer comprising 3 to 4 weight percent of the of the mixture.

Embodiments of the method of making the ceramic isolation ball may further include the step of subjecting the mixture to a partial vacuum that is between 300 and 700 mm Hg.

Embodiments of the method of making the ceramic isolation ball may further include the step of using a polymerization initiator comprising ammonium persulfate.

Embodiments of the method of making the ceramic isolation ball may further include the step of using a mold into which the ceramic slurry is poured that comprises one of metal, glass, plastic and wax.

Embodiments of the method of making a ceramic isolation ball may further include the step of using a catalyst comprising Azobis (2-amidinopropane) HCl (AZAP) to cause the monomers in the ceramic slurry to form large cross-linked polymer molecules to trap water within the gel matrix, to produce a rubbery polymer-water gel to immobilize ceramic particles within the slurry and to impart a desired spherical shape to the ceramic slurry of the void of the mold.

Embodiments of the method of making a ceramic isolation ball may further include the step of adding a catalyst in the amount of 10 weight percent of the ceramic slurry.

Embodiments of the method of making a ceramic isolation ball may further include the step of drying the isolation ball in air having a relative humidity greater than about 90%.

Embodiments of the method of making a ceramic isolation ball may further include the step of decreasing the humidity of the surrounding air, and increasing the temperature to speed up the drying step after a shrinkage phase.

Embodiments of the method of making a ceramic isolation ball may further include the step of applying a pliable coating or pliable cushions to the ceramic isolation ball to provide impact resistance to the ceramic isolation ball as it is transported within the well from the wellhead to the ball seat. The pliable coating or cushion also promotes effective sealing between the isolation ball and the ball seat. The pliable coating or cushion may, in one embodiment of the ceramic isolation ball of the present invention, be from 0.005 inches (0.0127 cm) to 0.05 inches (0.127 cm) in thickness, and may be applied by spraying a liquid product onto the ball and allowing the coating to cure and dry for one hour.

Embodiments of the method of making a ceramic isolation ball may further include the step of hot isostatic pressing after the last firing step to densify the ceramic material for improved resistance to cracking and to provide superior strength. Embodiments of a method of making the ceramic isolation ball may further include a processing step of casting or injection molding the bulk metallic glass to form the ball. Embodiments of a method of making the ceramic isolation ball may also include the processing step of injection-molding or isostatically pressing a ceramic powder into a spherical shape.

Embodiments of the method of making a ceramic isolation ball may further include the step of forming a first ceramic hemispherical ball portion and a second ceramic hemispherical ball portion, and the subsequent step of securing a face of the first ceramic hemispherical ball portion to the face of a second ceramic hemispherical ball portion to form the ceramic isolation ball. One embodiment includes the step of securing the first ceramic hemispherical ball portion to the second ceramic hemispherical ball portion using a threadably adjustable fastener with a male member and a female member, wherein the male member includes a shaft with exterior threads and a head, and the female member includes a shaft with interior threads and a head, wherein the head of the male member is secured at an opening of the first ceramic hemispherical ball portion after introducing the shaft of the male member through the opening, wherein the head of the female member is secured at an opening of the second ceramic hemispherical ball portion after introducing the shaft of the female member through the opening, and wherein a distal end of the male member is received into the distal end of the female member and the male member is rotated on its axis relative to the female member to threadably engage the male member to the female member and to adjust the length of the fastener comprised of the male member and female member threadably coupled thereto until the first ceramic hemispherical member is secured at the face to the face of the second ceramic hemispherical member.

Another embodiment of the method of making a ceramic isolation ball of the present invention includes the steps of forming a first ceramic hemispherical ball portion and a second ceramic hemispherical ball portion, the first ceramic hemispherical ball portion having a face with a plurality radially inwardly protruding threads and the second ceramic hemispherical ball portion having a face with a plurality of radially outwardly protruding threads that correspond in pitch to the radially outwardly protruding threads on the first ceramic hemispherical ball portion. The face of the first ceramic hemispherical ball portion can be engaged with the face of the second ceramic hemispherical ball portion, and the second ceramic hemispherical ball portion can be rotated to make up the threads on the first ceramic hemispherical ball portion with the corresponding threads on the second ceramic hemispherical ball portion to couple the first and second ceramic hemispherical ball portions to form a ceramic isolation ball.

### BRIEF DESCRIPTION OF THE SEVERAL VIEWS OF THE DRAWINGS

FIG. 1 is a sectional view of a well drilled into the earth's crust and illustrating a series of hydraulic fractures disposed at a predetermined spacing to enhance production and recovery of formation fluids from a hydraulically fractured subsurface geologic formation.

FIG. 2 is the sectional view of the well of FIG. 1 illustrating the lack of fractures within the targeted geologic formation prior to the creation of the hydraulic fractures and illustrating a location of a desired placement of a ball and a ball seat to receive the ball to thereby isolate zones deeper in the well than the ball seat (to the right) from zones shallower in the well than the ball seat (to the left).

FIG. 3 is a sectional elevation of an embodiment of a ball of the present invention received in a ball seat set within the casing of the drilled well illustrated in FIG. 2 to create an isolating seal.

FIG. 4 is a perspective view of one embodiment of a hollow, cast ceramic ball of the present invention.

FIG. 5 is a perspective view of a stainless steel plug for use in closing the opening of the embodiment of the ball of FIG. 4, the plug having spring-biased legs extending from an interior side of a plug cap.

FIG. 6 is an exploded view of an embodiment of a hollow, cast ceramic ball of the present invention comprising two hemispheres securable one to the other to form a ball by a fastener.

FIG. 7 is a sectional assembled view of the ball components of FIG. 6.

FIG. 8 is a view of an embodiment of a hollow, cast ceramic ball of the present invention comprising two hemispheres that are securable one to the other to form a ball by threads.

FIG. 9 is an assembled view of the ball components of FIG. 8.

### DETAILED DESCRIPTION

One embodiment of the present invention provides a ball having an outer surface of sufficient smoothness to enable the ball to seat within and to seal with a ball seat, wherein the ball has substantial resistance to deformation by an applied pressure differential across the seal created by the ball received within the ball seat. The embodiment of the ball of the present invention can include a solid or, preferably, a hollow interior.

The manner in which an embodiment of the ball of the present invention is made may vary, but will generally include the steps of gel-casting, slip-casting, isostatic pressing, injection molding and/or hot isostatic pressing (HIP) a ceramic powder into a ball shape. A hollow ball will typically have an entry hole which is made necessary by the casting process.

One embodiment of the hollow ceramic isolation ball of the present invention is made by mixing and milling a ceramic powder including alumina, zirconia-toughened alumina (ZTA), silicon nitride, tungsten carbide or zirconia, with water, a dispersant and one or more gel-forming organic monomers such as, for example, methacrylamide or hydroxymethlacrylamide (HMAM) to serve as a binder. The binder is preferably included in the range from 3 to 4 weight percent of the mixture. The mixture is subjected to a partial vacuum, preferably between 300 to 700 mm Hg, to remove air from the mixture and to prevent the formation of bubbles that may otherwise result in structural flaws or porosity in the final solidified product. A polymerization initiator such as, for example, ammonium persulfate, is added to the mixture to initiate a gel-forming chemical reaction and to thereby produce a ceramic slurry. The ceramic slurry is poured into molds of metal, glass, plastic or wax to cast the ceramic gel into the shape of a hollow spherical ball having an opening to receive a plug or cap.

The molds containing the cast ceramic gel are heated in a curing oven or a kiln. A catalyst such as, for example, 10 weight percent Azobis (2-amidinopropane) HCl (AZAP) causes the monomers in the ceramic slurry to form large cross-linked polymer molecules that trap water within the gel matrix, thereby providing a rubbery polymer-water gel. The gel permanently immobilizes the ceramic particles in the desired shape defined by the interior of the mold in which the ceramic gel is contained. Finally, the hardened isolation ball is removed from the mold.

The cast ceramic isolation ball is allowed to dry thoroughly to remove most of the solvent. It is preferable that the ball is allowed to dry at a high relative humidity (greater than about 90%) to minimize warping and cracking. During the drying step, a ceramic slurry that is about 50 weight percent solids will uniformly shrink in size by about 3%. The humidity of the surrounding air may be decreased and the temperature may be increased to speed up the drying step after the shrinkage phase is completed.

The resulting gel-cast ceramic ball is sufficiently soft that can be “green-machined” using tungsten carbide or steel tools. Green machining is machining the ceramic into a preferred shape prior to firing the ceramic ball. Once the ceramic is fired, the resulting ball can only be ground using diamond tooling, which is costly and time consuming. In the “green” state, machining is inexpensive and quick.

The final steps include the burning out of the binder and the sintering of the cast material. These two steps may be combined into a single step. The ceramic ball is allowed to air dry 1 to 2 days, and is then fired in furnace at a temperature ranging from 1600° C. to 1800° C. This heating procedure accomplishes two goals. First, water is removed as the ball dries. Second, water in the ball causes cracking during exposure to furnace heat. An initial temperature ramp to 1,022° F. (550° C.) enables the polymer remaining in the ceramic material to burn out. Removing the polymer from the ceramic material is required to prevent defects and cracks and enables densification of the ceramic body. Second, at the higher temperature from 1600° C. to 1800° C., the intense heat of the furnace sinters the ceramic to make it hard and dense.

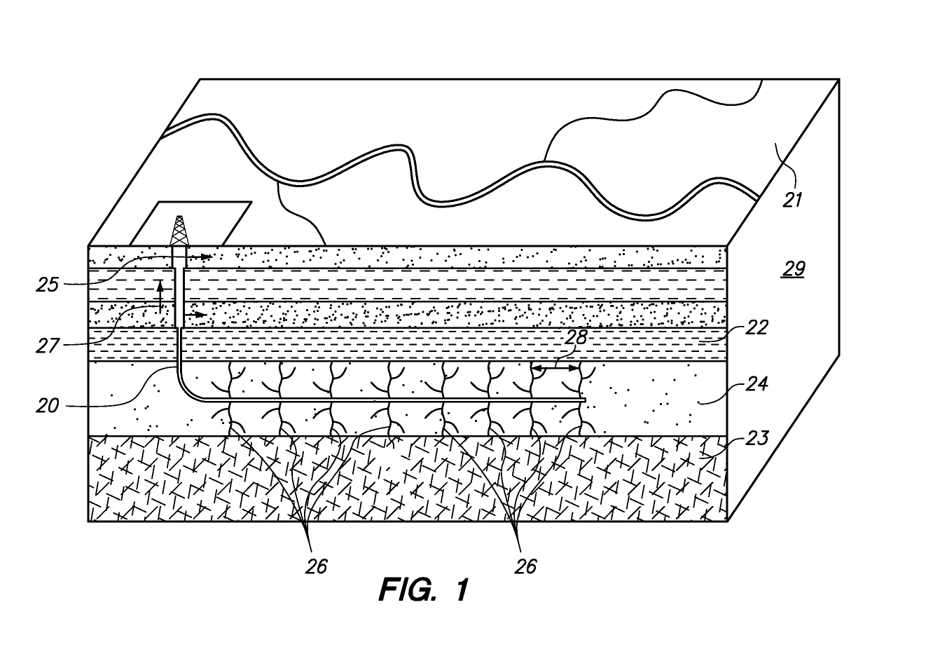

FIG. 1 is a sectional view of a well 20 drilled from the surface 21 into the earth's crust 29 and illustrating a series of hydraulic fractures 26 disposed at a predetermined spacing 28 to enhance production and recovery of formation fluids from a hydraulically fractured subsurface geologic formation 24. The drilled well 20 may include multiple layers of surface casing as is known in the art. The drilled well 20 may include one or more turns or changes in direction to align the portion of the well 20 to be perforated or otherwise to gather fluids within a known geological structure, seam or formation 24. The fractures 26 created in the formation 24 are generally disposed at a predetermined spacing 28 selected for optimal drainage. The targeted formation 24 may reside between a top layer 22 and an underlying layer 23 within the earth's crust 29. It will be understood that fluids entering the well 20 flow according to a pressure gradient in the direction of the arrow 27 to the surface for processing, storage or transportation.

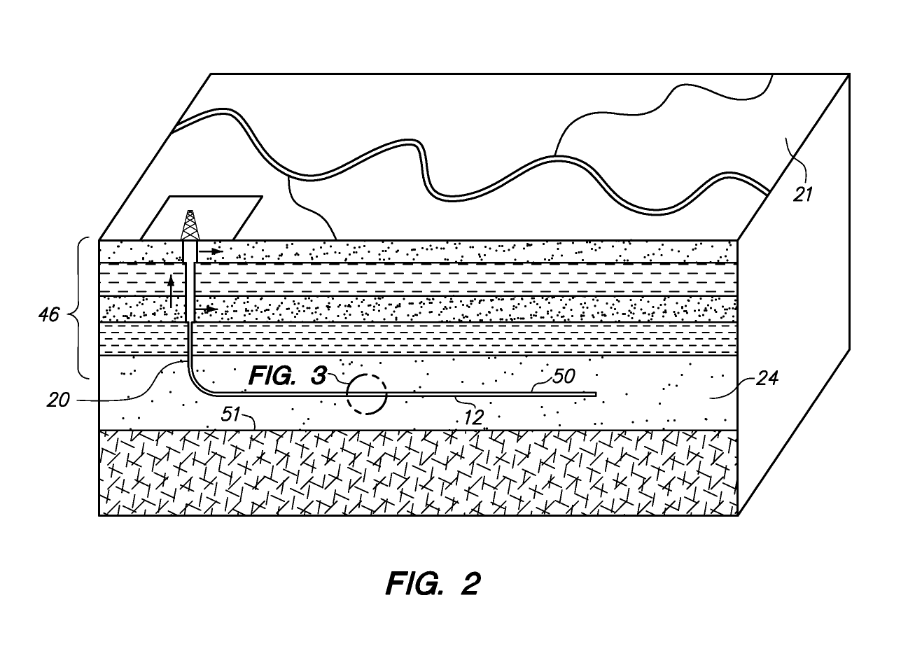

FIG. 2 is the sectional view of the well 20 of FIG. 1 illustrating the lack of fractures 26 (seen in FIG. 1) within the targeted geologic formation 24 prior to the creation of the hydraulic fractures shown in FIG. 1. FIG. 2 illustrates a location of a desired placement of a ball (not shown) and a ball seat (not shown) to receive the ball to thereby isolate a zone 50 that is deeper in the well than the ball seat (i.e., to the right) from a zone 51 that is shallower in the well 20 than the ball seat (i.e. to the left). It will be understood that the ball and ball seat are to be placed in a portion of the casing 12 that lies within the targeted geologic formation 24 and that the pressure at any given location within the well 20 is approximately equal to the pressure at a wellhead 49 at the surface 21 plus the product of the vertical elevation change 46 times the density (as measured in units corresponding to the unit used to measure depth) of a fluid residing in the well 20, assuming that the well 20 is filled with the fluid.

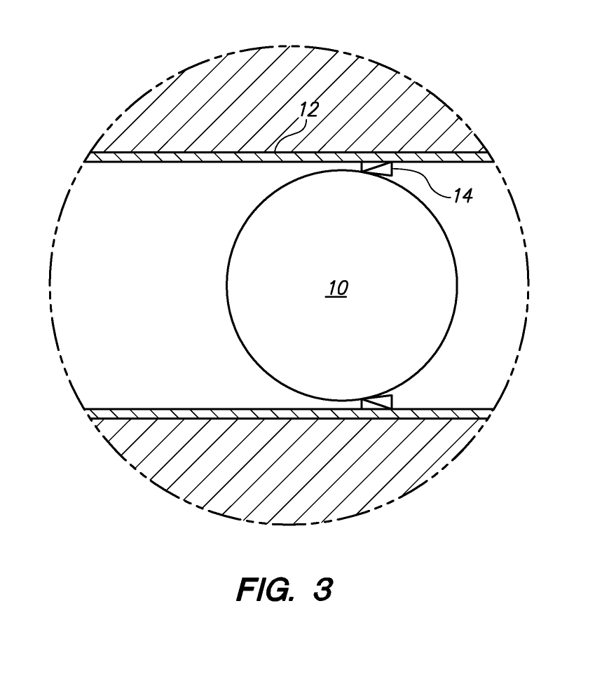

FIG. 3 is a sectional elevation of an embodiment of a ball 10 of the present invention received in a ball seat 14 set within a section of a casing 12 of the drilled well 20 (not shown in FIG. 3) illustrated in FIG. 2 to create an isolating seal. It will be understood that a number of tools exist for setting the ball seat 14 within the portion of the casing 12 in which the seal is to be affected, and that those tools and the methods of setting those tools are not within the scope of the present invention, and that FIG. 3 is provided merely to illustrate the manner in which an embodiment of a ball 10 engages the ball seat 14 after the ball seat 14 is set in the portion of the casing 12 and after the ball 10 is introduced into the well 20 and moved to the ball seat 14.

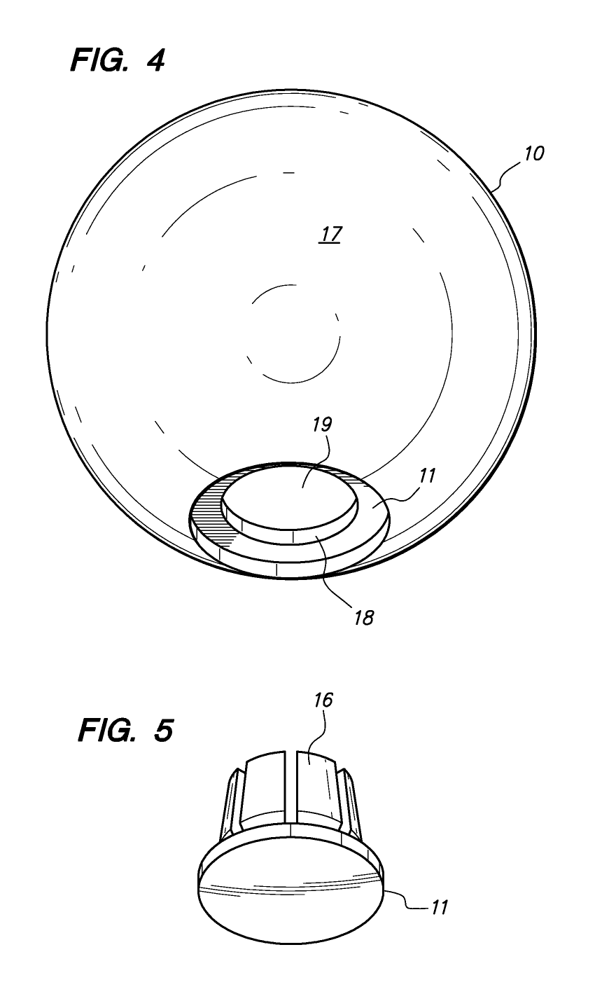

FIG. 4 is an elevation view of a hollow, cast ceramic ball of the present invention.

FIG. 4 is a sectional view of an embodiment of a ball 10 of the present invention. The ball 10 of FIG. 4 comprises a hollow interior 19, an exterior surface 17, a hole 18 in the exterior surface 17.

FIG. 5 is a perspective view of a stainless steel plug 11 having spring-biased legs 16 extending from an interior side of a plug 11. The plug 11 is preferably comprised of stainless steel but can be made of most alloys or metals. The plug 11 of FIG. 5 is shown aligned with the hole 18 in the ball 10 for being fitted into the hole 18 to close the hole 18 and to seal the hole 18 against fluid intrusion so that the ball 10 can maintain a desired effective density. It will be understood that, absent a seal at the plug 11 received into the hole 18, the hollow interior 19 of the ball 10 will fill with fluid, thereby making the ball 10 heavier and thereby adversely affecting the effective density of the ball 10.

The embodiment of the ball 10 illustrated in FIGS. 3-5 seals against the ball seat 14 (see FIG. 3) to isolate formation zones below the ball seat 14 from the one or more formation zones above the ball seat 14 to allow the zones above the ball seat 14 to be fractured without affecting the zones below the ball seat 14.

The configuration of the well 20 and the depth at which the ball seat 14 and the ball 10 are to be used determine the size of the ball seat 14 and the ball 10. The range of sizes of the ball 10 may be within the range from 1.75 inches (4.45 cm) to 4 inches (10 cm), or larger. The size of the hole 18 in the hollow ball 10 can, in one embodiment, range from 0.2 inches (5 mm) to 1 inch (25.4 mm).

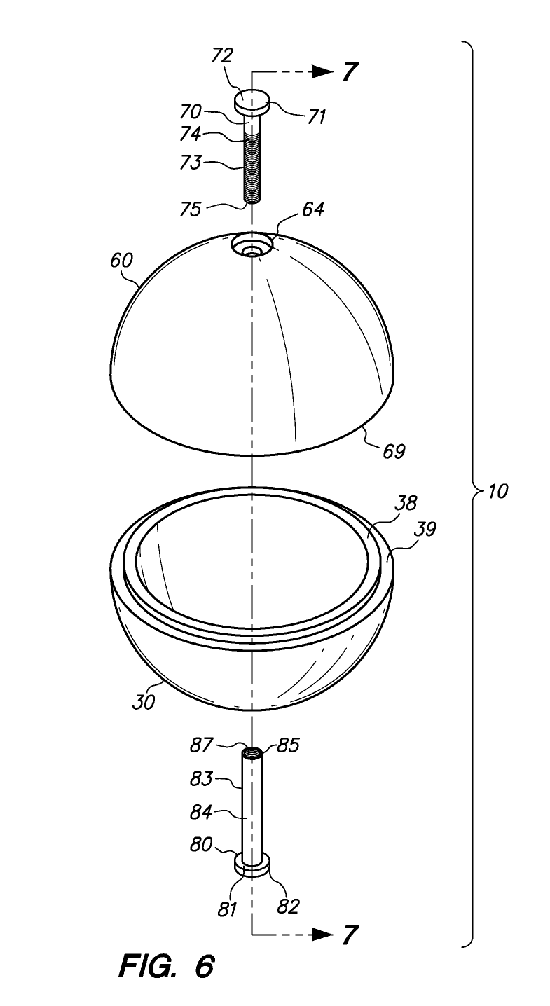

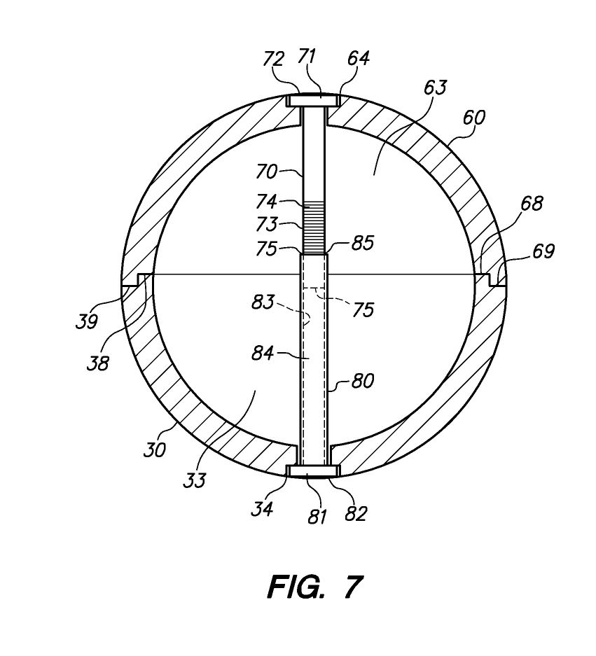

FIG. 6 is an exploded view of an embodiment of a hollow, cast ceramic ball 10 of the present invention comprising two hemispheres 30 and 60 securable one to the other to form a ball 10 by a fastener comprising a male member 70 and a female member 80. The upper hemisphere 60 in FIG. 6 includes an opening 64 to receive the distal end 75 and the externally threaded shaft 73 of the male member 70. The male member 70 further includes a head 72 at a proximal end 71 of the male member 70 to engage the hemisphere 60. The lower hemisphere 30 in FIG. 6 includes an opening (not shown) opposite to the opening 64 of the upper hemisphere 60 to receive the distal end 85 and internally threaded shaft 84 of the female member 80. The female member 80 further includes a head 82 at a proximal end 81 of the female member 80 to engage the hemisphere 30. The pitch of the threads 74 along the threaded shaft 73 of the male member 70 correspond to the pitch of the internal threads 87 within the shaft 84 of the female member 80, and the distal end 75 of the male member 70 can be received within the distal end 85 of the female member 80 and the male member 70 can then be rotated relative to the female member 80 to threadably couple the male member 70 to the female member 80. It will be understood that the head 72 at the proximal end 71 of the male member 70 will be adducted to the head 82 at the proximal end 81 of the female member 80 as the male member 70 and the female member 80 are threadably made up, and the two hemispheres 30 and 60 will be secured one to the other by making up the threaded connection between the male member 70 and the female member 80. Optionally, the mating faces 39 and 69 of the lower hemisphere 30 and the upper hemisphere 60, respectively, may include mating profiles such as, for example, a protruding lip 38 on the face 39 of the lower hemisphere 30 that is received into a corresponding recess 68 (not shown on FIG. 6—see FIG. 7) on the face 69 of the upper hemisphere 30.

FIG. 7 is a sectional assembled view of the ball 10 components of FIG. 6. The distal end 75 of the male member 70 can be seen in dotted line form received within the distal end 85 of the female member 80.

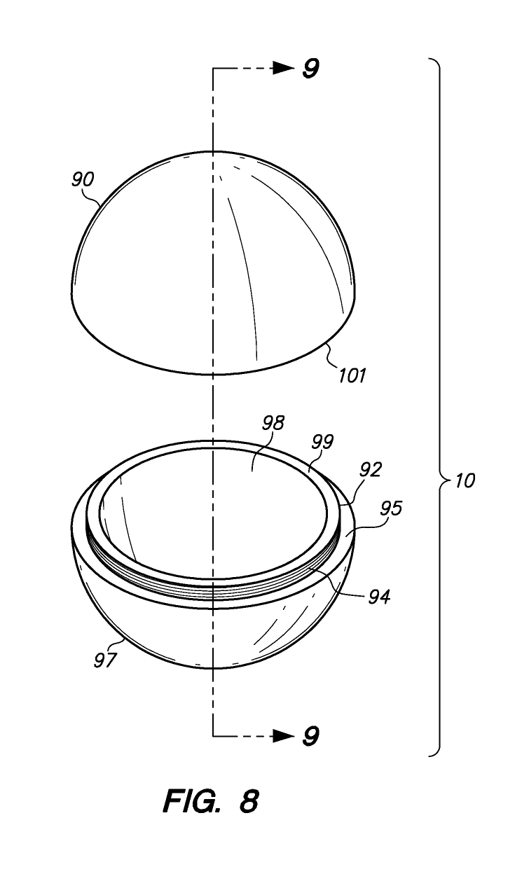

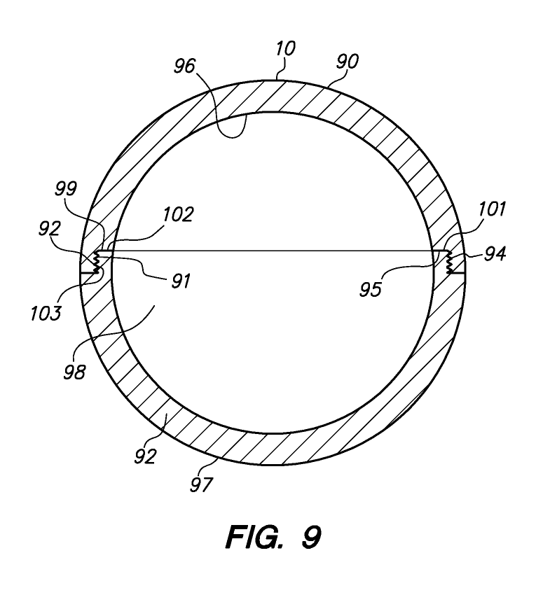

FIG. 8 is a view of an embodiment of a hollow, cast ceramic ball 10 of the present invention comprising two hemispheres 90 and 97 that are securable one to the other to form a ball 10 by threads 92. The lower hemisphere 97 in FIG. 8 includes a face 95 having a protruding lip 99 and threads 92 disposed on a radially outwardly portion 94 of the protruding lip 99. The face 101 of the upper hemisphere 90 (not shown in FIG. 8—see FIG. 9) includes a recess 102 (not shown in FIG. 8) that corresponds to and receives the protruding lip 99 of the lower hemisphere 97 upon assembly. An interior portion 103 of the recess 102 of the upper hemisphere 90 includes threads 91 that correspond to and mate with the threads 92 on the protruding lip 99 on the lower hemisphere 97.

FIG. 9 is an assembled view of the ball 10 components of FIG. 8. The threads 91 on the interior portion 103 of the recess 102 of the upper hemisphere 90 are seen as being made up with the threads 92 on the radially outwardly portion 94 of the protruding lip 99 of the lower hemisphere 97 to secure the upper hemisphere 90 to the lower hemisphere 97.

Embodiments illustrated in FIGS. 1-9 are not to be considered as limiting of the scope of the present invention, which is limited only by the claims that follow.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of making an isolation ball for use with a ball seat disposed within an earthen well to isolate the pressure within a first portion of the well from the pressure in a second portion of the well, comprising:
mixing and milling a ceramic powder with water, a dispersant and one or more gel-forming organic monomers to serve as a binder to form a mixture;
subjecting the mixture to a partial vacuum to remove air from the mixture and to prevent the formation of bubbles that may otherwise result in structural flaws or porosity in the final solidified product;
adding a polymerization initiator to the mixture to initiate a gel-forming chemical reaction and to thereby produce a ceramic slurry;
adding a catalyst to the ceramic slurry;
pouring the ceramic slurry into a molds to cast having a void in the shape of a hollow spherical ball having an opening to receive a plug;
heating the mold containing the ceramic gel in a curing oven or a kiln for a period within the range of 30 to 800 minutes at a temperature of 200° C. to 800° C.;
removing the hardened isolation ball from the mold;
drying the isolation ball to remove most of the solvent and to minimize warping and cracking;
green machining the ceramic ball into a spherical shape;
firing the ceramic ball;
exposing the ceramic ball to heat for a sustained duration of time in a furnace to burn out the binder and sinter the cast material;
air drying the ceramic ball at ambient temperature for a period of about 1 to 2 days;
firing the ceramic ball in furnace at a temperature ranging from 2,912° F. (1600° C.) to 3,272° F. (1800° C.) for a duration of from 1 to 4.5 hours to densify the ceramic; and
receiving a plug into a hole in the ball to seal the hollow interior.

2. The method of claim 1, wherein the ceramic powder comprises one of alumina, zirconia-toughened alumina, silicon nitride, tungsten carbide, zirconia and bulk metallic glass.

3. The method of claim 1, wherein the monomer comprises one of methacrylamide and hydroxymethlacrylamide.

4. The method of claim 1, wherein the monomer comprises 3 to 4 weight percent of the mixture.

5. The method of claim 1, wherein the partial vacuum is between 300 mm of Hg to 700 mm of Hg.

6. The method of claim 1, wherein the polymerization initiator comprises ammonium persulfate.

7. The method of claim 1, wherein the mold into which the ceramic slurry is poured comprises one of metal, glass, plastic and wax.

8. The method of claim 1, wherein the catalyst comprises Azobis (2-amidinopropane) HCl (AZAP) to cause the monomers in the ceramic slurry to form large cross-linked polymer molecules to trap water within the gel matrix, to produce a rubbery polymer-water gel to immobilize ceramic particles within the slurry and to impart a desired spherical shape to the ceramic slurry of the void of the mold.

9. The method of claim 8, wherein the catalyst is added 10 weight percent of the ceramic slurry.

10. The method of claim 1, wherein drying the isolation ball to remove most of the solvent and to minimize warping and cracking comprises the isolation ball in air having a relative humidity greater than about 90%.

11. The method of claim 1, further comprising:
decreasing the humidity of the surrounding air; and
increasing the temperature to speed up the drying step after a shrinkage phase.

12. The method of claim 1, further comprising:
hot-isostatic pressing the ceramic ball to further densify and strengthen the ball.

13. The method of claim 1, further comprising:
applying one of a pliable coating and a plurality of pliable cushions to an exterior surface of the ceramic ball in a thickness of from 0.005 inches to 0.05 inches in thickness; and
allowing the one of the pliable coating and the pliable cushions to one of dry and cure in air prior to being introduced into the well.

14. A method of manufacturing an isolation ball for use with a ball seat to isolate the pressure within a first portion of a well drilled into the earth's crust from the pressure in a second portion of the well, comprising:
mixing and milling a ceramic powder with water, a dispersant and one or more gel-forming organic monomers to serve as a binder to form a mixture;
subjecting the mixture to a partial vacuum to remove air from the mixture and to deter the formation of bubbles in the final solidified product;
adding a polymerization initiator to the mixture to initiate a gel-forming chemical reaction and to thereby produce a ceramic slurry;
adding a catalyst to the ceramic slurry;
pouring the ceramic slurry into a mold to cast a body in the shape of a hollow spherical ball having an opening to sealably receive a plug;
heating the mold containing the ceramic gel in a curing oven or a kiln for a period within the range of 30 to 800 minutes at a temperature of 200° C. to 800° C.;
removing the hardened ceramic ball from the mold;
drying the ceramic ball to remove solvent;
green machining the ceramic ball into a spherical shape;
firing the ceramic ball;
exposing the ceramic ball to heat for a sustained duration of time in a furnace to burn out the binder and sinter the cast material;
air drying the ceramic ball at ambient temperature for a period of about 1 to 2 days;
firing the ceramic ball in furnace at a temperature ranging from 2,912° F. (1600° C.) to 3,272° F. (1800° C.) for a period within the range of 1 to 4.5 hours to densify the ceramic; and
sealably receiving a plug into the opening in the ball to seal the hollow interior.

15. The method of claim 14, wherein the ceramic powder comprises one of alumina, zirconia-toughened alumina, silicon nitride, tungsten carbide, zirconia and bulk metallic glass.

16. The method of claim 14, wherein the monomer comprises one of methacrylamide and hydroxymethlacrylamide.

17. The method of claim 14, wherein the monomer comprises 3 to 4 weight percent of the mixture.

18. The method of claim 14, wherein the partial vacuum is between 300 mm of Hg to 700 mm of Hg.

19. The method of claim 14, wherein the polymerization initiator comprises ammonium persulfate.

20. A method of manufacturing an isolation ball for use with a ball seat to isolate the pressure within a first portion of a well drilled into the earth's crust from the pressure in a second portion of the well, comprising:
mixing and milling a ceramic powder with water, a dispersant and one or more gel-forming organic monomers to serve as a binder to form a mixture;
subjecting the mixture to a partial vacuum to remove air from the mixture and to deter the formation of bubbles in the final solidified product;
adding a polymerization initiator to the mixture to initiate a gel-forming chemical reaction and to thereby produce a ceramic slurry;
adding a catalyst to the ceramic slurry;
pouring the ceramic slurry into a first mold to cast a body in the shape of a first hollow hemispherical ball portion having an opening to receive a first fastener component;
pouring the ceramic slurry into a second mold to cast a body in the shape of a second hollow hemispherical ball having an opening to receive a second fastener component;
heating the first and second molds containing the ceramic gel in a curing oven or a kiln for a period within the range of 30 to 800 minutes at a temperature of 200° C. to 800° C.;
removing the hardened hollow hemispherical ceramic ball portions from the first and second molds;
drying the hollow hemispherical ceramic ball portions to remove solvent;
green machining the hollow hemispherical ceramic ball portions into a smoothed hollow hemispherical shape;
firing the first and second hollow hemispherical ceramic ball portions;
exposing the first and second hollow hemispherical ceramic ball portions to heat for a sustained duration of time in a furnace to burn out the binder and sinter the cast material;
air drying the first and second hollow hemispherical ceramic ball portions at ambient temperature for a period of about 1 to 2 days;
firing the ceramic ball in furnace at a temperature ranging from 2,912° F. (1600° C.) to 3,272° F. (1800° C.) for a period within the range of 1 to 4.5 hours to densify the ceramic; and
receiving a distal end of a male member, having a head at a proximal end, into the opening in the first hollow hemispherical ceramic ball portion;
receiving a distal end of a female member, having a head at a proximal end, into the opening in the second hollow hemispherical ceramic ball portion;
disposing a face of the first hollow hemispherical ceramic ball portion into engagement with the face of the second hollow hemispherical ceramic ball portion;
receiving the distal end of the male member into the distal end of a female member; and
rotating the male member relative to the female member to threadably secure the face of the first hollow hemispherical ceramic ball portion to the face of the second hollow hemispherical ceramic ball portion to form a hollow ceramic ball.
